(19) United States
(12) Patent Application Publication
(10) Pub. No.: US 2026/0321907 A1
(43) Pub. Date: Oct. 15, 2026

(54) INTEGRATED BATTERY AND BATTERY SAFETY PROTECTION METHOD

(71) Applicant: Guangdong Future Era Technology Co., Ltd., Shenzhen (CN)

(72) Inventors: Chunsheng HUANG, Shenzhen (CN); Xiafeng ZENG, Shenzhen (CN); Huachao CHENG, Shenzhen (CN); Xianjin LIN, Shenzhen (CN)

(21) Appl. No.: 19/250,111

(22) Filed: Jun. 26, 2025

(30) Foreign Application Priority Data
Apr. 15, 2025 (CN) 202510468539.8

(51) Int. Cl. H01M 50/531; H01M 50/119; H01M 50/186; H01M 50/528; H01M 50/578; H01M 50/586; H02J 7/60; H02J 7/61; H02J 7/62; H02J 7/63; H02J 7/64; H02J 7/65; H01M 50/107

(52) U.S. Cl. CPC H01M 50/531; H01M 50/119; H01M 50/186; H01M 50/528; H01M 50/578; H01M 50/586; H02J 7/61; H02J 7/62; H02J 7/63; H02J 7/64; H02J 7/65; H02J 7/663; H01M 50/107; H01M 2200/105

(57) ABSTRACT

The present disclosure relates to the field of lithium ion batteries, and in particular, to an integrated battery and a battery safety protection method. The integrated battery of the present disclosure includes: a steel shell provided with a mounting cavity and a protective cavity therein; a sealing ring mounted in the protective cavity of the steel shell; a winding core mounted in the mounting cavity; wherein the winding core is connected to a positive electrode tab and a negative electrode tab, and the negative electrode tab is electrically connected to the negative electrode; a metal ring electrically connected to the positive electrode tab.

### TECHNICAL FIELD

The present disclosure relates to the field of lithium ion batteries, and in particular, to an integrated battery and a battery safety protection method.

### BACKGROUND ART

Lithium ion battery is a very important energy storage technology. The battery generally uses the material containing lithium as the electrode, which is the representative of modern high-performance battery. Due to its excellent performance, it is widely used in mobile phones, computers, solar energy, new energy vehicles, electric vehicles and communication base stations, home energy storage and other fields.

A lithium ion battery is a kind of secondary battery (rechargeable battery), which mainly relies on lithium ions to move between a positive electrode and a negative electrode to operate. Li+ moves back and forth between the two electrodes through intercalation and deintercalation during charging and discharging. During charging, Li+ is deintercalated from the positive electrode and intercalated into the negative electrode via the electrolyte, resulting in a lithium-rich state in the negative electrode. The reverse process occurs during discharging. Lithium ion batteries have a high energy density and a high average output voltage. The self-discharge is small, and the battery is below 2% per month (recoverable). It has no memory effect. The working temperature range is wide from -20°C to 60 °C. It has excellent cycle performance, fast charge and discharge, high charging efficiency up to 99%, and high output power. Service life is long. It does not contain toxic or hazardous substances, and is called green battery.

Lithium ion batteries are packaged in many different forms, including steel-shell, aluminum-shell, cylindrical, and flexible-package designs. Among them, lithium ion cylindrical batteries are widely used, but there is no protection circuit in the existing batteries, so it is necessary to add a protection plate afterwards, and all the protection plates are placed on the side or bottom of the battery, which belongs to negative electrode protection, and the protection function is small; at the same time, when the existing batteries are overcharged, there is no better protection measures, and the safety of the batteries is low.

### SUMMARY OF THE INVENTION

An object of the present disclosure is to solve the problem that the conventional lithium ion battery cannot automatically and timely perform safety protection when an overcharge occurs or a high-pressure gas expands inside the battery. Therefore, the present disclosure proposes an integrated battery and a battery safety protection method, wherein when a high voltage occurs inside a battery, the electrical connection of a battery winding core can be automatically disconnected, thus bringing about corresponding technical effects in view of the existing problems.

In order to solve the above-mentioned technical problem, the integrated battery of the present disclosure includes:
a steel shell provided with a mounting cavity and a protective cavity therein; wherein the steel shell has a negative electrode;
a sealing ring mounted in a protection cavity of the steel shell, wherein the sealing ring sealing an inner cross section of the protection cavity; further including a positive electrode 4;
a winding core mounted in the mounting cavity; wherein the winding core is connected to a positive electrode tab and a negative electrode tab, and the negative electrode tab is electrically connected to the negative electrode;
a metal ring electrically connected to the positive electrode tab;
a connecting aluminum plate fixedly mounted in the sealing ring; wherein the connecting aluminum plate is at least partially welded connected to the metal ring; and the connecting aluminum plate is electrically connected to the positive electrode.

As a preferred embodiment of the integrated battery of the present disclosure, a diameter of the metal ring is smaller than a diameter of the connecting aluminum plate; the metal ring has at least two through-holes penetrating upper and lower surfaces thereof.

As a preferred embodiment of the integrated battery of the present disclosure, a protection circuit mounted in the sealing ring is included; wherein the protection circuit is electrically connected to the connecting aluminum plate and the positive electrode.

As a preferred embodiment of the integrated battery of the present disclosure, a negative electrode ring located in the sealing ring is included, wherein the negative electrode ring is electrically connected to the protection circuit.

As a preferred embodiment of the integrated battery of the present disclosure, a positive electrode ring welded to the protection circuit is included; wherein the positive electrode ring is located within the sealing ring; the positive electrode ring is located between the connecting aluminum plate and the negative electrode ring.

As a preferred embodiment of the integrated battery of the present disclosure, the protection circuit includes:
a charging part for managing battery charging, controlling voltage and current, and preventing overcharging; wherein the charging part is a charging management IC, and includes an overvoltage protection circuit and an overcurrent protection circuit;
an LED part for providing a status indication, and driving the LED to display via different signals; wherein the LED part is composed of a constant current chip, and a bi-color LED is used to switch a flashing mode, and is driven by the charging management IC output signal, and the LED current is controlled by a current limiting resistor;
an NTC part for monitoring a temperature of a battery core so as to achieve temperature monitoring and trigger the protection mechanism at high temperature; wherein the NTC part includes a negative temperature coefficient thermistor, the negative temperature coefficient thermistor and the winding core constitute a voltage dividing circuit, a resistance value decreases as the temperature increases, and a temperature signal is transmitted to the charging management IC via the voltage dividing circuit;
a discharging part for step-down conversion, stable output of 1.5V, and providing protection function; wherein the discharging part includes a discharge MOSFET, a current detection resistor, an inductor, an output capacitor and a feedback resistor network; the discharge MOSFET is used for controlling a current path; the current detection resistor is used for monitoring a discharge current and realizing overcurrent protection in cooperation with an operational amplifier; the inductor is used for energy storage filtering; the output capacitor is used for smoothing an output voltage; the feedback resistor network is used for adjusting the output voltage to 1.5V;
wherein the LED part is electrically connected to the charging part and the discharging part, respectively; the charging part is electrically connected to the discharging part; and the discharging part is electrically connected to the NTC part.

As a preferred embodiment of the integrated battery of the present disclosure, the NTC part monitors a temperature of the winding core while the protection circuit is charging, and the charging part is started if it is normal; managing battery charging by the charging part, the bi-color LED alternately flashes; the NTC part continuously monitors the temperature.

As a preferred embodiment of the integrated battery of the present disclosure, the NTC part and the discharging part are jointly protected when the protection circuit is discharged, and a 1.5V output of the battery is cut off when a cell voltage reaches a termination voltage; the NTC part continuously monitors the temperature.

As a preferred embodiment of the integrated battery of the present disclosure, the charging management IC triggers a protection mechanism including protection actions for overcharge, overdischarge, overtemperature, and overcurrent according to temperature, voltage, and current data.

A battery safety protection method of the present disclosure includes the integrated battery described in any one of the above items, wherein when the battery generates a pressurized gas inside the steel shell of the integrated battery due to overcharge, short circuit or abnormal gas generation, an expansion pressure of the pressurized gas is used to push up a connecting aluminum plate of the integrated battery to generate a deformation, and the deformation of the connecting aluminum plate is used to disconnect a welding point between the connecting aluminum plate and a metal ring, thereby achieving overvoltage protection.

### Advantageous Effects

The present disclosure solves the above-mentioned prior art problems and other prior art problems not mentioned above, and accordingly brings about at least the following innovative advantages:

In the integrated battery and battery safety protection method of the present disclosure, the connection relationship between the metal ring and the connecting aluminum plate 9 enables the metal ring and the connecting aluminum plate to be mounted in the steel shell of the battery, and when a high-pressure gas appears in the steel shell of the battery, the gas can be used to push the connecting aluminum plate to deform, thereby achieving the disconnection of the metal ring and the connecting aluminum plate, which greatly improves the safety for the use of the battery.

According to the integrated battery and the battery safety protection method of the present disclosure, through the structural design between the metal ring and the connecting aluminum plate, in combination with the protection circuit of the present disclosure, it is realized that the integrated battery has double safety protection when applied to a battery.

### BRIEF DESCRIPTION OF THE DRAWINGS

FIG. 1 is a schematic view showing an overall effect of the present disclosure;

FIG. 2 is a circuit diagram of the present disclosure.

In the figures: 1. steel shell, 2. mounting cavity, 3. protective cavity, 4. positive electrode, 5. negative electrode, 6. sealing ring, 7. winding core, 8. metal ring, 9. connecting aluminum plate, 10. insulating layer, 11. protective circuit, 12. negative electrode ring, 13. positive electrode ring.

### DETAILED DESCRIPTION OF THE INVENTION

In order to make the purpose, technical solution, and advantages of the technical solution of the present disclosure clearer, the following text will provide a clear and complete description of the technical solution of the embodiments of the present disclosure in conjunction with the accompanying drawings of the specific embodiments.

Like reference numbers in the various drawings indicate like elements. The described embodiments are some, but not all embodiments of the present disclosure.

Based on the described embodiments of the present disclosure, all other embodiments that a person of ordinary skill in the art would obtain without inventive effort are within the scope of protection of the present disclosure.

Example 1

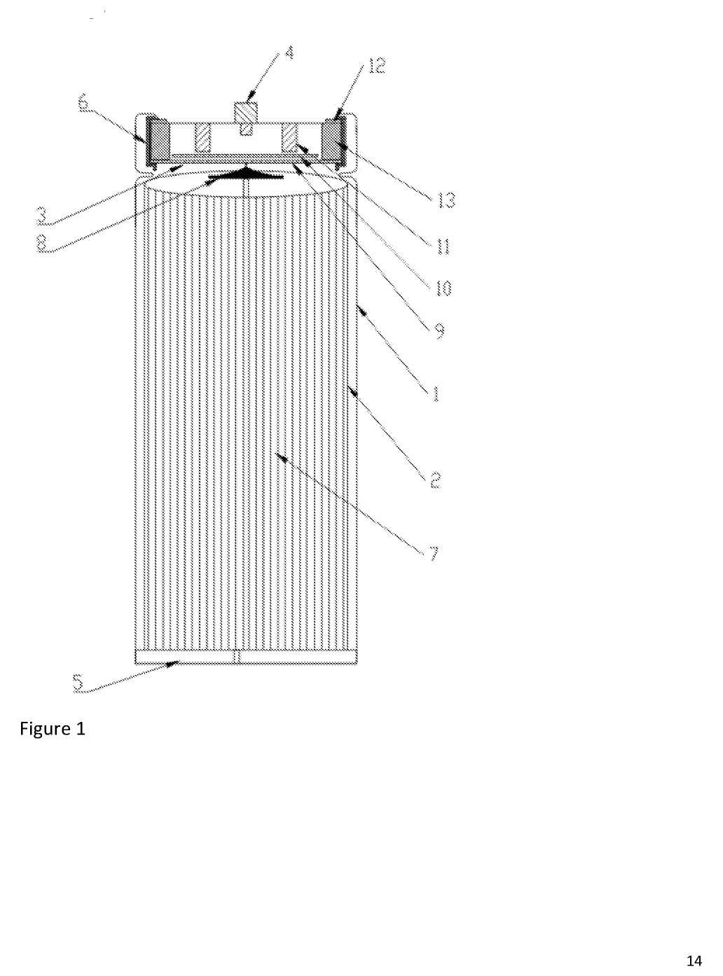

As shown in FIG. 1, the integrated battery of the present disclosure includes: a steel shell 1, wherein the steel shell 1 is a shell of a battery; the steel shell 1 is provided with a mounting cavity 2 and a protective cavity 3; the steel shell 1 has a negative electrode 5; FIG. 1 illustrates that the steel shell 1 has a groove line around its circumference, with which the mounting cavity 2 and the protective cavity 3 are formed;

a sealing ring 6, wherein the sealing ring 6 is a rubber ring, the sealing ring 6 is mounted in the protection cavity 3 of the steel shell 1, and the sealing ring 6 seals the inner cross section of the protection cavity 3, and further including a positive electrode 4;

a winding core 7, wherein FIG. 1 shows the winding core 7 mounted in the mounting cavity 2; the winding core 7 is connected to a tab of a positive electrode 4 and a tab of a negative electrode 5, and the tab of the negative electrode 5 is electrically connected to the negative electrode 5;

a metal ring 8, wherein the metal ring 8 is electrically connected to the tab of the positive electrode 4;

a connecting aluminum plate 9, wherein the connecting aluminum plate 9 is fixedly mounted in the sealing ring 6; the connecting aluminum plate 9 is at least partially welded to the metal ring 8; the connecting aluminum plate 9 is electrically connected to the positive electrode 4; the diameter of the metal circular ring 8 is smaller than the diameter of the connecting aluminum plate 9; the metal ring 8 has at least through-holes penetrating upper and lower surfaces; FIG. 1 shows that an insulating layer 10 is further included, and the insulating layer 10 is provided between the connecting aluminum plate 9 and the protection circuit 11. The design of the metal ring 8 and the connecting aluminum plate 9 of the present disclosure is such that when the internal pressure in the steel shell 1 is greater than 1.0 MPa or the voltage of the winding core 7 is greater than 4.8V, and the electrolyte vaporizes and the internal pressure increases to greater than 1.0 MPa, the metal ring 8 and the connecting aluminum plate 9 are disconnected under the effect of the increase in the internal pressure, so that the battery is disconnected and the charging is no longer continued, thus preventing a safety accident from occurring.

As shown in FIG. 1, a protection circuit 11 is included, and the protection circuit 11 is mounted in the sealing ring 6; and the protection circuit 11 is electrically connected to the connecting aluminum plate 9 and the positive electrode 4. A negative electrode ring 12 located inside the sealing ring 6 is included, wherein the negative electrode ring 12 is electrically connected to the protection circuit 11. A positive electrode ring 13 welded to the protection circuit 11 is included; wherein the positive electrode ring 13 is located inside the sealing ring 6; the positive electrode ring 13 is located between the connecting aluminum plate 9 and the negative electrode ring 12. As shown in FIG. 1, the positive ring 13 is located at a circle around the inner wall of the sealing ring 6, and by controlling the size of the inner diameter of the positive ring, it can be used to prevent different components from contacting with the connecting aluminum plate 9 from being short-circuited. The negative electrode ring is welded on the output face of the PCB plate, and is used as a steel shell 1 to prevent the edge of the sealing buckle from breaking/buckling the PCB plate during sealing, so that the contact internal resistance is lower.

The material of the above-mentioned positive electrode ring 13 is PTC or a metal ring; during use in a battery, when the material of the above-mentioned positive electrode ring 13 is PTC, the positive electrode ring 13 is used for the connection between the protection circuit 11 and the connecting aluminum plate 9; and when a charging or discharging current is excessive or a short circuit occurs, the battery stops charging or discharging, so as to play a safety protection role. When the material of the positive electrode ring 13 is a metal ring, it is only responsible for the connection between the protection circuit 11 and the connecting aluminum plate 9.

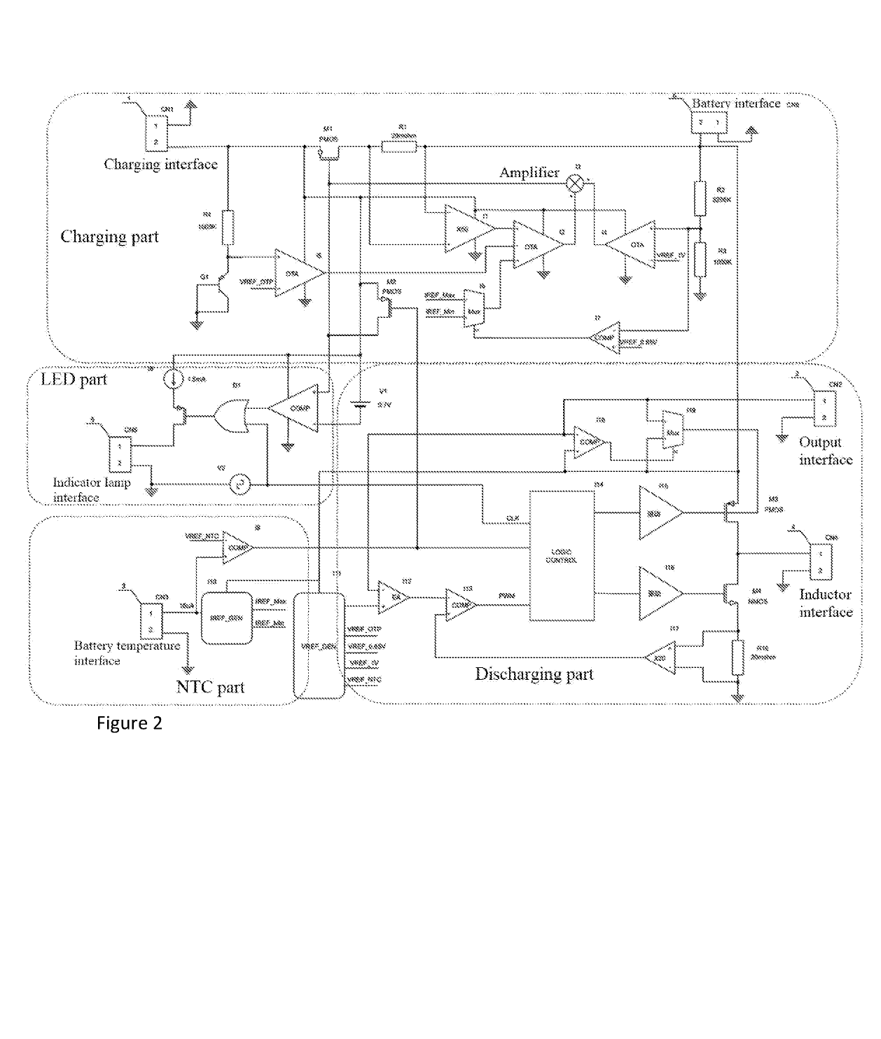

As shown in FIG. 2, wherein the above-mentioned protection circuit 11 includes: a charging part for managing battery charging, controlling voltage and current, and preventing overcharging; wherein the charging part is a charging management IC, and includes an overvoltage protection circuit 11 and an overcurrent protection circuit 11;

an LED part for providing a status indication, and driving the LED to display via different signals; wherein the LED part is composed of a constant current chip, and a bi-color LED is used to switch a flashing mode, and is driven by the charging management IC output signal, and the LED current is controlled by a current limiting resistor;

an NTC part for monitoring a temperature of a battery core so as to achieve temperature monitoring and trigger the protection mechanism at high temperature; wherein the NTC part includes a negative temperature coefficient thermistor, the negative temperature coefficient thermistor and the winding core 7 constitute a voltage dividing circuit, a resistance value decreases as the temperature increases, and a temperature signal is transmitted to the charging management IC via the voltage dividing circuit;

a discharging part for step-down conversion, stable output of 1.5V, and providing protection function; wherein the discharging part includes a discharge MOSFET, a current detection resistor, an inductor, an output capacitor and a feedback resistor network; the discharge MOSFET is used for controlling a current path; the current detection resistor is used for monitoring a discharge current and realizing overcurrent protection in cooperation with an operational amplifier; the inductor is used for energy storage filtering; the output capacitor is used for smoothing an output voltage; the feedback resistor network is used for adjusting the output voltage to 1.5V;

wherein the LED part is electrically connected to the charging part and the discharging part, respectively; the charging part is electrically connected to the discharging part; and the discharging part is electrically connected to the NTC part.

Furthermore, the NTC part monitors a temperature of the winding core 7 while the protection circuit is charging, and the charging part is started if it is normal; managing battery charging by the charging part, the bi-color LED alternately flashes; the NTC part continuously monitors the temperature.

Furthermore, the NTC part and the discharging part are jointly protected when the protection circuit is discharged, and a 1.5V output of the battery is cut off when a cell voltage reaches a termination voltage; the NTC part continuously monitors the temperature.

Furthermore, the charging management IC triggers a protection mechanism including protection actions for overcharge, overdischarge, overtemperature, and overcurrent according to temperature, voltage, and current data.

Example 2

A battery safety protection method of the present disclosure includes the integrated battery as described in Example 1, wherein when the battery generates a pressurized gas inside the steel shell 1 of the integrated battery due to overcharge, short circuit or abnormal gas generation, an expansion pressure of the pressurized gas is used to push up a connecting aluminum plate 9 of the integrated battery to generate a deformation, and the deformation of the connecting aluminum plate 9 is used to disconnect a welding point between the connecting aluminum plate 9 and a metal ring 8, thereby achieving overvoltage protection.

According to the integrated battery and battery safety protection method of the present disclosure, the connection relationship between the metal ring 8 and the connecting aluminum plate 9 enables the metal ring 8 and the connecting aluminum plate 9 to be mounted in the steel shell 1 of the battery, and when a high-pressure gas appears in the steel shell of the battery, the gas can be used to push the connecting aluminum plate 9 to deform, thereby achieving the disconnection of the metal ring 8 and the connecting aluminum plate 9, which greatly improves the safety for the use of the battery.

According to the integrated battery and the battery safety protection method of the present disclosure, through the structural design between the metal ring 8 and the connecting aluminum plate 9, in combination with the protection circuit 11 of the present disclosure, it is realized that the integrated battery has double safety protection when applied to a battery.

The use of the terms "first", "second", and the like in the description and in the claims does not denote any order, quantity, or importance, but rather is used to distinguish different components. Also, the terms "a", "an", or "the" do not denote a limitation of quantity, but rather denote the presence of at least one. Terms such as "including" or "containing" refer to elements or articles that appear before "including" or "containing", including those listed after "including" or "containing" and their equivalents, and do not exclude other elements or articles. “Up", "down", "left", "right", etc. are only used to indicate a relative positional relationship, which may change accordingly when the absolute position of the object being described changes.

The above described preferred embodiments of the present disclosure are not intended to limit the present disclosure. The scope of protection of the present disclosure is limited by the accompanying claims. For ordinary technical personnel in this field, other embodiments and any modifications based on the claims of the present disclosure can be obtained according to the accompanying drawings without exerting creative labor, which are within the scope of protection of the present disclosure.

1. An integrated battery, comprising:
a steel shell provided with a mounting cavity and a protective cavity therein; wherein the steel shell has a negative electrode;
a sealing ring mounted in a protection cavity of the steel shell, wherein the sealing ring sealing an inner cross section of the protection cavity; further comprising a positive electrode;
a winding core mounted in the mounting cavity; wherein the winding core is connected to a positive electrode tab and a negative electrode tab, and the negative electrode tab is electrically connected to the negative electrode;
a metal ring electrically connected to the positive electrode tab;
a connecting aluminum plate fixedly mounted in the sealing ring; wherein the connecting aluminum plate is at least partially welded connected to the metal ring; and the connecting aluminum plate is electrically connected to the positive electrode.

2. The integrated battery according to claim 1, wherein a diameter of the metal ring is smaller than a diameter of the connecting aluminum plate; the metal ring has at least two through-holes penetrating upper and lower surfaces thereof.

3. The integrated battery according to claim 1, comprising a protection circuit mounted in the sealing ring; wherein the protection circuit is electrically connected to the connecting aluminum plate and the positive electrode.

4. The integrated battery according to claim 3, comprising a negative electrode ring located in the sealing ring, wherein the negative electrode ring is electrically connected to the protection circuit.

5. The integrated battery according to claim 3, comprising a positive electrode ring welded to the protection circuit; wherein the positive electrode ring is located within the sealing ring; the positive electrode ring is located between the connecting aluminum plate and the negative electrode ring.

6. The integrated battery according to claim 3, wherein the protection circuit comprises:
a charging part for managing battery charging, controlling voltage and current, and preventing overcharging; wherein the charging part is a charging management IC, and comprises an overvoltage protection circuit and an overcurrent protection circuit;
an LED part for providing a status indication, and driving the LED to display via different signals; wherein the LED part is composed of a constant current chip, and a bi-color LED is used to switch a flashing mode, and is driven by the charging management IC output signal, and the LED current is controlled by a current limiting resistor;
an NTC part for monitoring a temperature of a battery core so as to achieve temperature monitoring and trigger the protection mechanism at high temperature; wherein the NTC part comprises a negative temperature coefficient thermistor, the negative temperature coefficient thermistor and the winding core constitute a voltage dividing circuit, a resistance value decreases as the temperature increases, and a temperature signal is transmitted to the charging management IC via the voltage dividing circuit;
a discharging part for step-down conversion, stable output of 1.5V, and providing protection function; wherein the discharging part comprises a discharge MOSFET, a current detection resistor, an inductor, an output capacitor and a feedback resistor network; the discharge MOSFET is used for controlling a current path; the current detection resistor is used for monitoring a discharge current and realizing overcurrent protection in cooperation with an operational amplifier; the inductor is used for energy storage filtering; the output capacitor is used for smoothing an output voltage; the feedback resistor network is used for adjusting the output voltage to 1.5V;
wherein the LED part is electrically connected to the charging part and the discharging part, respectively; the charging part is electrically connected to the discharging part; and the discharging part is electrically connected to the NTC part.

7. The integrated battery according to claim 3, wherein the NTC part monitors a temperature of the winding core while the protection circuit is charging, and the charging part is started if it is normal; managing battery charging by the charging part, the bi-color LED alternately flashes; the NTC part continuously monitors the temperature.

8. The integrated battery according to claim 3, wherein the NTC part and the discharging part are jointly protected when the protection circuit is discharged, and a 1.5V output of the battery is cut off when a cell voltage reaches a termination voltage; the NTC part continuously monitors the temperature.

9. The integrated battery according to claim 3, wherein the charging management IC triggers a protection mechanism comprising protection actions for overcharge, overdischarge, overtemperature, and overcurrent according to temperature, voltage, and current data.

10. A battery safety protection method, comprising the integrated battery according to claim 1, wherein, when the battery generates a pressurized gas inside the steel shell of the integrated battery due to overcharge, short circuit or abnormal gas generation, an expansion pressure of the pressurized gas is used to push up a connecting aluminum plate of the integrated battery to generate a deformation, and the deformation of the connecting aluminum plate is used to disconnect a welding point between the connecting aluminum plate and a metal ring, thereby achieving overvoltage protection.
